(19) United States
(12) Patent Application Publication
(10) Pub. No.: US 2018/0238202 A1
(43) Pub. Date: Aug. 23, 2018

(54) Beam Coupling

(71) Applicant: Maxitrol Company, Southfield, MI (US)

(72) Inventors: Mark Geoffrey Masen, Leonard, MI (US); Jason Sagovac, Dearborn Heights, MI (US)

(73) Assignee: Maxitrol Company, Southfield, MI (US)

(21) Appl. No.: 15/899,725

(22) Filed: Feb. 20, 2018

Related U.S. Application Data
(60) Provisional application No. 62/460,967, filed on Feb. 20, 2017.

(51) Int. Cl. F01L 1/46; G01F 1/26; F01L 9/02; F16K 31/06

(52) U.S. Cl. CPC F01L 1/462; G01F 1/26; F01L 2820/00; F16K 31/0651; F01L 9/02

(57) ABSTRACT

A beam coupling includes a spring extending between top and bottom plates to transmit rotational motion while providing longitudinal compressibility and accommodating axial misalignment without loss of effective and efficient operation; a fluid flow control system may include a beam coupling operatively disposed between a motor and a valve.

### RELATED APPLICATIONS

This application claims priority to and the benefit of U.S. Provisional Patent Application No. 62/460,967, filed on Feb. 20, 2017, the entire contents of which are hereby incorporated by reference.

### TECHNICAL FIELD

The present invention relates, generally, force transmission and, more specifically, to a beam coupling.

### BACKGROUND

Fluid control systems use a variety of valve types to turn fluid flow on and off, and also to modulate the flow rate through a fluid circuit. Conventional control systems may include valves having complex mechanisms including many components and complicated assemblies. These valves require the input of force or motion, either linear or rotational, in order to effect the desired control parameter. Therefore, conventional control systems may include valves operationally connected with one or more motors or solenoids for providing the needed linear, translational motion or rotational motion.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 shows an exemplary embodiment of a beam coupling according to the present disclosure in an oblique perspective view.

FIG. 2 shows a side view of the beam coupling of FIG. 1.

FIG. 3 shows an end view of the beam coupling of FIG. 1.

FIGS. 4A and 4B shows a side view of the beam coupling of FIG. 1 in an unloaded and a load-applied configuration.

FIG. 5 shows a schematic representative diagram of the beam coupling in connection with a fluid flow control system.

### DETAILED DESCRIPTION

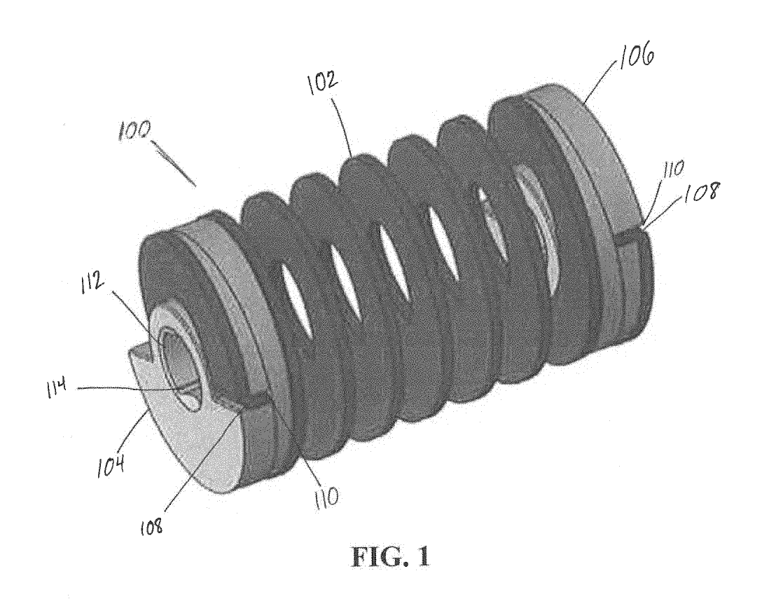

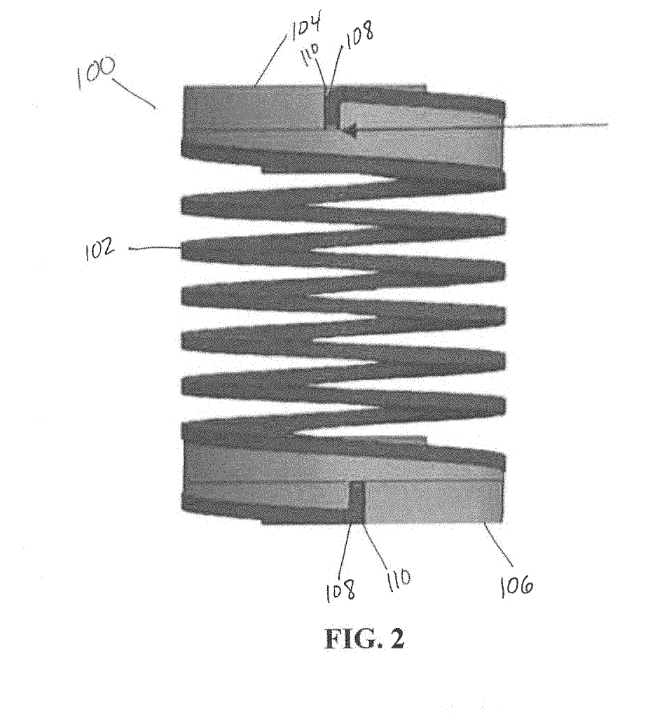

With reference now to the drawings, FIGS. 1-3 shows an exemplary embodiment of a beam coupling 100 according to the present disclosure in an oblique perspective view along with side and end views. The beam coupling 100 includes a spring 102 extending between top and bottom plates 104 and 106. The spring 102 is secured to each of the top and bottom plates 104 and 106. A leg 108 extends at each end of the spring 102 and is received in a pocket 110 provided for that purpose in the top and bottom plates 104 and 106.

The spring 102 provides the beam coupling 100 with longitudinal and torsional resiliency upon a longitudinal deflection along an axis of the coupling or upon a rotational deflection about the axis. The spring 102 is illustrated in the Figures with a rectangular cross section. Alternative embodiments may employ springs of other cross-sectional forms, including for example, square or round cross-sections. In further alternative embodiments, a pair of round cross-sectioned springs arranged side-by-side may be employed. The spring 102 may be formed of a metal material, such as steel. In alternative embodiments, the spring 102 may be formed of a polymer, metal alloy, or other suitable material.

The spring 102 is illustrated with a particular number of coils, forming a length and width. It will be appreciated that the number of coils, the length and the width of the spring 105 employed in the beam coupling 100 will be determined according to the intended application of the beam coupling 100, including the force conditions, deflection amount and other considerations known in the art for spring design.

The spring 102 includes legs 108 extending at each end of the spring 102 formed integrally with the coils of the spring 102. The legs 108 are illustrated extending inward at an angle to the coils of the spring 102. In alternative embodiments, the legs 108 of the spring 102 may extend outward. In further alternative embodiments, an aperture may be formed in the spring material and the spring 102 may be secured to the top and bottom plates 104 and 106 with a pin, bolt, or other fastener.

The top and bottom plates 104 and 106 provide the beam coupling 100 a mechanical interface with beam shafts (not shown) extending from the beam coupling 100. The designation of “top” and “bottom” is simply to differentiate between the two plates at opposite ends of the beam coupling, and is not reflective of any particular installation or operational orientation. As described above, the spring 102 includes legs 108 retained in pockets 110 of the top and bottom plates 104 and 106. In alternative embodiments, the pockets 110 may be formed to receive legs 108 extending outwardly, rather than inwardly as depicted. In further alternative embodiments, the pockets 110 may include apertures for receiving a pin, bolt, or other fastener.

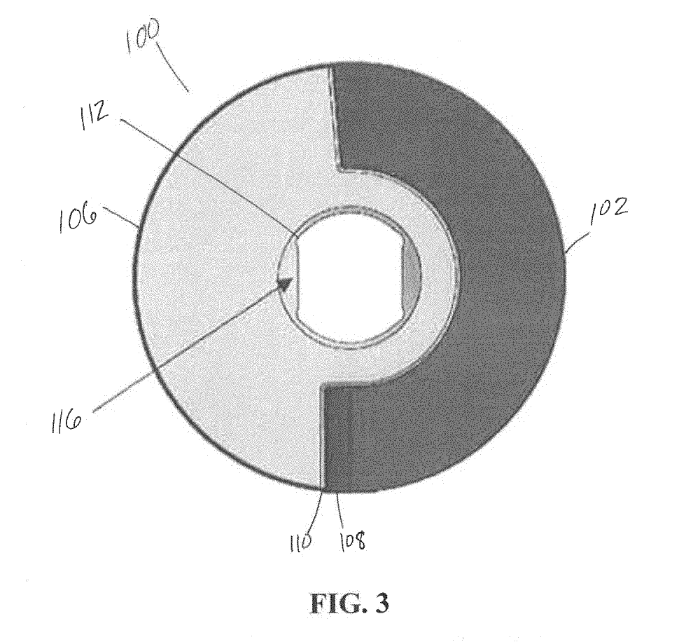

The top and bottom plates 104 and 106 further include central apertures 112 for receiving beam shafts (not shown). The central aperture 112 may include a complementary profile with the profile of the beam shaft to facilitate transmission of rotational force or motion. In the embodiment illustrated in FIG. 1, the end plate 104 is shown with a D-stem profile 114 for receiving round shaft having a single flat surface. In the embodiment illustrated in FIG. 3, the end plate 106 is shown with a double D-stem profile 116 for receiving a round shaft having two opposing flat surfaces. In further alternative embodiments, the central apertures 112 of the top and bottom plates 104 and 106 may include alternative profiles corresponding to the profile of a particular beam design, including splines, threaded interfaces, and other suitable profiles conventional in the art.

The top and bottom plates 104 and 106 may be formed of a metal material, including a steel material. In alternative embodiments, the top and bottom plates 104 and 106 may be formed of a polymeric or other suitable material, for example an acetal resin (e.g. Delrin) or acetate.

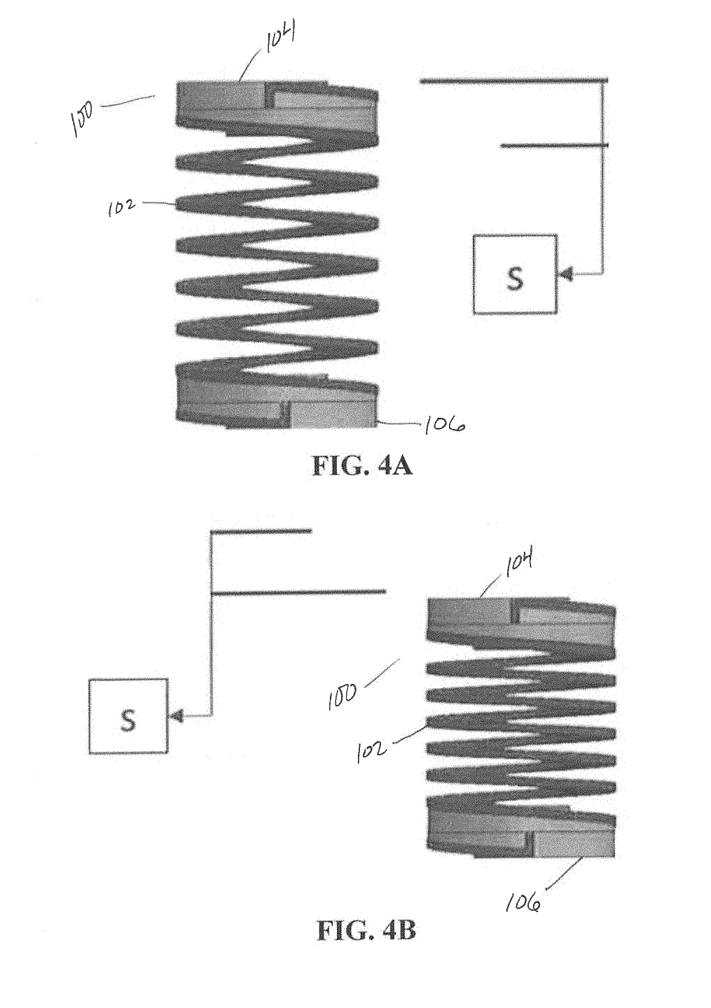

FIGS. 4A and 4B show the beam coupling 100 in an unloaded and a load-applied condition, respectively. In an unloaded condition, the spring 102 extends an uncompressed length. This unloaded condition may be present when the beam coupling 100 is employed in a fluid control system with a valve in a fully open state. The valve may advantageously be a multifunction valve, such as is disclosed and described in U.S. patent application Ser. No. 15/414,767, the entirety of which is incorporated herein by reference. As shown in FIG. 4B, the spring 102 is compressed by distance S in a load-applied condition. The beam coupling 100 may have a compressive load applied when the beam coupling 100 is employed in a fluid control system with the valve in a partially or fully-closed condition.

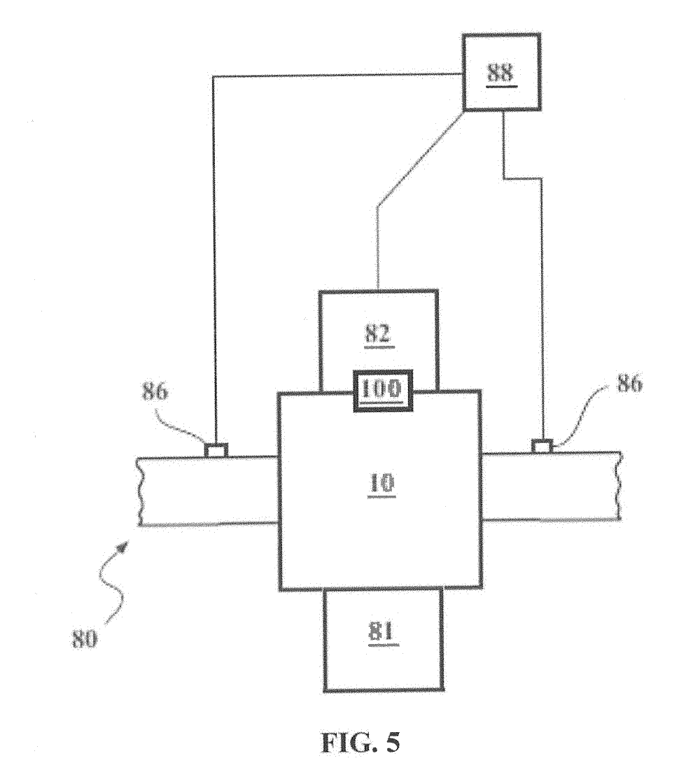

FIG. 5 shows a schematic representative diagram of the beam coupling 100 in connection with a fluid flow control system. The beam coupling 100 may be employed in a fluid flow control system to couple a first beam as the output shaft of a motor 82 with a second beam as the control shaft of a valve 10. Rotation of the control shaft controls the rotation of a gate for partially sealing the valve to reduce fluid flow therethrough. The control shaft may extend through the valve to interface with a solenoid 81, disposed opposite the motor relative to the valve. The solenoid may control a translational displacement of the control shaft in the valve to fully seal the valve independent of the rotation of the valve gate.

In order to maintain effective and efficient control of the fluid control system, the system optimally maintains a coaxial alignment of the motor shaft with the valve control shaft and the solenoid. Operation of the fluid flow control system may be impeded with any misalignment of the motor, the valve or the solenoid. The beam coupling 100 according to the present disclosure overcomes these limitations to provide effective and efficient control of the fluid control system even in the presence of misalignment between the system components. The beam coupling 100 acts as a torsional spring to communicate the rotational motion of the motor to the valve gate. The beam coupling 100 also acts as a compression spring to accommodate the displacement of the solenoid when the valve is closed and thereafter urge the valve to its open state when the solenoid is deactivated. The beam coupling 100 provides compliance for axial and/or radial misalignment without binding or backlash.

A method of controlling fluid flow includes operating a motor, transmitting the motion generated by the motor through a beam coupling 100 as described above; closing a valve gate within a valve by rotating a valve gate by the motion transmitted through the beam coupling 100.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A beam coupling, comprising:
a spring having a first end and a second end;
a first plate; and
a second plate; the spring extending between first and second plates and wherein the first end is attached to the first plate and the second end is attached to the second plate.

2. The beam coupling of claim 1, wherein the spring has longitudinal and torsional resiliency to transmit both longitudinal and rotational deflection.

3. The beam coupling of claim 1, wherein the spring includes a first leg and a second leg, the first and second legs disposed at the first and second ends respectively.

4. The beam coupling of claim 3, wherein the first plate and the second plate include a first pocket and a second pocket, respectively; and wherein the first and second legs are received in the first and second pockets.

5. The beam coupling of claim 3 wherein the first leg extends at the first end toward the second end, and wherein the second leg extends at the second end toward the first end.

6. The beam coupling of claim 1, wherein the spring is a coil spring formed having a rectangular cross-section.

7. The beam coupling of claim 1, wherein the first plate and the second plate include a first aperture and a second aperture, respectively.

8. The beam coupling of claim 7, wherein the first and second aperture comprise d-stem profiles, respectively.

9. A method of controlling a fluid flow through a multifunction valve, the method comprising:
operating one of a motor to generate a rotational control motion, a solenoid to generate translational control motion, or a combination of motor and solenoid to generate a combination of a translational control motion and a rotational control motion;
transmitting the rotational control motion and/or translational control motion by a beam coupling, the beam coupling comprising a spring having a first end and a second end, a first plate, and a second plate, the spring extending between first and second plates and wherein the first end is attached to the first plate and the second end is attached to the second plate; and
controlling the fluid flow through the multifunction valve in response to the rotational and/or translational control motion.
